(19) United States
(12) Patent Application Publication
(10) Pub. No.: US 2026/0301192 A1
(43) Pub. Date: Oct. 1, 2026

(54) SYSTEM AND METHOD FOR TRACKING ASSOCIATION USING CHARACTERISTICS OF OBJECT

(71) Applicants: HYUNDAI MOTOR COMPANY, Seoul (KR); Kia Corporation, Seoul (KR)

(72) Inventor: Su Min JO, Gyeonggido (KR)

(21) Appl. No.: 19/343,688

(22) Filed: Sep. 29, 2025

(30) Foreign Application Priority Data
Mar. 26, 2025 (KR) 10-2025-0038959

(51) Int. Cl. G06T 7/20; B60W 60/00

(52) U.S. Cl. CPC G06T 7/20; B60W 60/00

(57) ABSTRACT

An artificial intelligence (AI)-based system and a method for recognizing and tracking an object in conjunction with an autonomous driving sensor. A priority is assigned to a tracking channel of a tracking object for the autonomous driving sensor, depending on a classification type and classification information of the tracking object. A validation gate is determined, depending on the classification information and classification type of the tracking object, and candidate modals are filtered for association score calculation. An association score is determined based on the classification type and classification information of the tracking object, and a modal is selected that has largest similarity with the tracking object based on the calculated association score. Information about the selected modal is processed and track information for the selected modal is updated.

### CROSS-REFERENCE TO RELATED APPLICATION

Pursuant to 35 U.S.C. § 119(a), this application claims the benefit of an earlier filing date and right of priority to Korean Patent Application No. 10-2025-0038959, filed in the Korean Intellectual Property Office on Mar. 26, 2025, the entire contents of which are hereby incorporated herein by reference.

### TECHNICAL FIELD

The present disclosure relates to a system and a method for recognizing an object based on artificial intelligence (AI) and an autonomous driving sensor.

### BACKGROUND

Recently, with the increased development and commercialization of autonomous vehicles, there has been an increase in examples of using various sensors and an artificial intelligence (AI) technology to support an autonomous driving function of the vehicle. For example, using sensors and AI for autonomous driving can involve determining which object is present in front of a vehicle which is driving, the distance between the object and the vehicle, or selecting and executing appropriate algorithms for the vehicle to respond to specific situations to ensure safety.

As vehicle sensor technology becomes more advanced, there is a trend towards implementing vehicles with high-performance sensors, such as light detection and ranging (LiDAR) for recognizing a surrounding environment using laser beams, radio detection and ranging (RADAR) using radio waves, an ultrasonic sensor, a fisheye camera capable of capturing a 360-degree image, a multifocal lens, and a global positioning system (GPS).

In some scenarios, measured results obtained from a plurality of sensors can be aggregated to implement a so-called super sensor vehicle. The concept of a super sensor in self-driving or autonomous driving refers to a technology for combining measured values of various sensors to more accurately recognize a surrounding environment, rather than relying on an individual sensor, for convenience or safety of vehicle driving. As information and communications technology (ICT) and cloud technology becomes prevalent in vehicular environments, sensors for autonomous driving and AI algorithms for processing sensor data are becoming more advanced than ever. For example, scenarios include remotely accumulating data in a fleet of vehicles, rather than targeting only one vehicle, and training an AI server and a database to increase the reliability of processing data from the vehicle sensor.

### SUMMARY

According to an aspect of the present disclosure, an artificial intelligence (AI)-based system for recognizing and tracking an object in conjunction with an autonomous driving sensor may include a processor and a memory storing instructions that, when executed by the processor, perform operations for recognizing an object in a surrounding environment from a plurality of pieces of point data input from the autonomous driving sensor. The operations may include assigning a priority to a tracking channel of the autonomous driving sensor depending on object recognition importance and managing a type of a tracking object and classification information of the tracking object, setting a different validation gate depending on the type of the tracking object and filtering an association score calculation candidate group, calculating an association score based on the type of the tracking object and the classification information of the tracking object, selecting a modal with a largest similarity with the tracking object based on the calculated association score, and processing information about the selected modal and updating track information for the selected modal.

In the system for tracking association using the characteristics of the object according to another aspect of the present disclosure, the type of the tracking object may be at least one of a moving object type, a stationary object type, or an unknown object type.

In the system for tracking association using the characteristics of the object according to another aspect of the present disclosure, the priority for the tracking channel of the autonomous driving sensor may be determined in an order of the moving object type, the stationary object type, and the unknown object type.

In the system for tracking association using the characteristics of the object according to another aspect of the present disclosure, association may be performed in the order of the moving object type, the stationary object type, and the unknown object type for modal information input from the autonomous driving sensor.

In the system for tracking association using the characteristics of the object according to another aspect of the present disclosure, the determining of the validation gate and the filtering of the plurality of candidate modals may be performed based on the classification information of the tracking object and deep learning-based modal input information.

In the system for tracking association using the characteristics of the object according to another aspect of the present disclosure, the validation gate may be variably determined based on the type of the tracking object and the classification information of the tracking object.

In the system for tracking association using the characteristics of the object according to another aspect of the present disclosure, the updating of the track information in the fifth step may include generating a new track. The new track corresponding to the moving object type or the stationary object type may be generated after verification in a channel for the unknown object type is completed.

In the system for tracking association using the characteristics of the object according to another aspect of the present disclosure, an input from multiple sensors may be data with compatibility with an interface in a standardized format, for the multiple sensors in which the autonomous driving sensor is plural in number.

In the system for tracking association using the characteristics of the object according to another aspect of the present disclosure, track information including a position, a shape, and a speed of a track may be updated using associated modal information, if there is association between the track and an input modal. A track which is not associated with the input modal may be maintained during a certain duration in a coasting state, if there is no association between the track and the input modal.

In the system for tracking association using the characteristics of the object according to another aspect of the present disclosure, the selecting of the modal that has largest similarity with the tracking object may be executed according to a Hungarian algorithm to determine a matching in which the sum of similarities between a track and a modal is maximum.

According to another aspect of the present disclosure, an artificial intelligence (AI)-based method for recognizing and tracking an object in conjunction with an autonomous driving sensor may include assigning a priority to a tracking channel of the autonomous driving sensor depending on object recognition importance and managing a type of a tracking object and classification information of the tracking object, setting a different validation gate depending on the type of the tracking object and filtering an association score calculation candidate group, calculating an association score based on the type of the tracking object and the classification information of the tracking object, selecting a modal with a largest similarity with the tracking object based on the calculated association score, and processing information about the selected modal and updating track information for the selected modal.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example of the overall system for controlling a vehicle to automatically recognize an object and perform autonomous driving according to an implementation of the present disclosure;

FIG. 2 is a flowchart illustrating an example of the overall process of executing tracking association using characteristics of an object according to an implementation of the present disclosure;

FIG. 3 is a block flowchart illustrating an example of the overall process of executing tracking association using characteristics of an object according to an implementation of the present disclosure;

FIG. 4 is a drawing illustrating an example of an adoptable Hungarian algorithm according to an implementation of the present disclosure;

FIG. 5 is an example of an experimental result illustrating that objects with different adjacent pieces of classification information and characteristics are recognized with improved separation performance as a result of executing tracking association using characteristics of an object according to an implementation of the present disclosure; and

FIG. 6 is a block diagram illustrating an example of a computing system for autonomous vehicle control and object recognition computation according to an implementation of the present disclosure.

### DETAILED DESCRIPTION

Implementations of the present disclosure provide a technology for performing association based on a priority that is assigned according to a type of a tracking object for multi-modal-based input information. Such technology can help improve association and maintenance performance about an object by leveraging deep learning-based input information for providing a box with a stable shape and classification information using an identified classification type.

In scenarios where an autonomous driving system recognizes objects of various classes, such as a vehicle, a vulnerable road user (VRU) (or a vulnerable road user such as a pedestrian), a road boundary, and a road structure, a problem can occur if the algorithm applies the same association algorithm regardless of a recognized target. In particular, deterioration in tracking performance can occur, for example, if different types of recognized targets merge with each other or are incorrectly associated with each other and are not recognized. Furthermore, problems can occur if resource constraints preclude an important object from being recognized due to object recognition for an earlier-recognized object occupying the resources.

Problems can also occur if an autonomous driving system applies a validation gate with the same size and same association logic to different objects which can result in, for example, the object recognition algorithm merging a pedestrian with another adjacent recognized target (e.g., a vehicle, a road structure, or the like). In such scenarios, a driving control error can occur due to delayed or sudden recognition of the pedestrian while in a driving state.

Implementations of the present disclosure provide a system and a method for performing association based on a priority for each tracking channel. These techniques can use identified classification type information which is an advantage of deep learning-based modal input information. This can help reduce errors in which an object with a large recognition priority is not recognized and can help reduce a computation load and improve an association error problem.

Particularly, implementations of the present disclosure can utilize a scoring scheme for assigning a priority to a tracking channel with large recognition importance and determining a similarity using an algorithm for reflecting a characteristic for each tracking object depending on the type of the tracking object.

In addition, implementations of the present disclosure can calculate a validation gate that is suitable for object classification information, and filter an association score calculation candidate group based on the object classification information. As such, implementations of the present disclosure can calculate an association score for determining a similarity between the tracking object and the input modal information using object characteristic information using the type of the object and the classification information of the object and may finally select a modal with the largest similarity with the tracking object based on the calculated association score. Thereafter, implementations of the present disclosure can update track information, such as a position, a speed, or a shape, using the track associated with the input modal object and modal information.

Implementations of the present disclosure can implement a technology for performing association based on the priority according to the type of the tracking object, reducing non-recognition and an error in association via gate adjustment and score calculation using the object classification information, and stably maintaining the tracking object, via the above five steps.

In addition, those skilled in the air may understand various effects other than the effects described above from the present disclosure, via the detailed description of the present disclosure and the accompanying drawings.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

Hereinafter, some implementations of the present disclosure will be described in detail with reference to the exemplary drawings. In adding the reference numerals to the components of each drawing, it should be noted that the identical component is designated by the identical numerals even when they are displayed on other drawings. Further, in describing the implementation of the present disclosure, a detailed description of well-known features or functions will be ruled out in order not to unnecessarily obscure the gist of the present disclosure.

In describing components of exemplary implementations of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

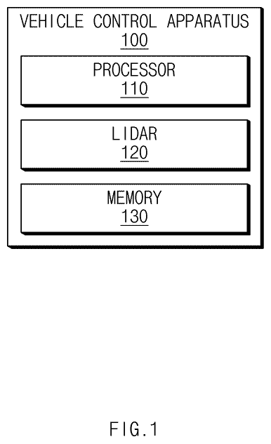

FIG. 1 is a block diagram illustrating an example of the overall system for controlling a vehicle to automatically recognize an object and perform autonomous driving according to an implementation of the present disclosure.

Referring to FIG. 1, a vehicle control apparatus 100 according to an implementation of the present disclosure may be implemented inside or outside a vehicle and some of the components included in the vehicle control apparatus 100 may be implemented inside or outside the vehicle. For example, the vehicle control apparatus 100 may be integrally configured with control units in the vehicle or may be implemented as a separate device to be connected with the control units of the vehicle by a separate connection technique. For example, the vehicle control apparatus 100 may further include components which are not shown in FIG. 1.

The vehicle control apparatus 100 according to an implementation may include a processor 110, a sensor 120 such as light detection and ranging (LiDAR), and a memory 130. The processor 110, the sensor 120, and the memory 130 may be electronically or operably coupled with each other by an electronical component such as a communication bus.

Hereinafter, that pieces of hardware are operably coupled with each other may include that a direct connection or an indirect connection between the pieces of hardware is established wired and/or wirelessly, such that second hardware is controlled by first hardware among the pieces of hardware.

Although different blocks are illustrated in FIG. 1, implementations are not limited thereto. For example, some of the pieces of hardware of FIG. 1 may be included in a single integrated circuit including a system on a chip (SoC). Types of the pieces of hardware included in the vehicle control apparatus 100 and/or the number of the pieces of hardware are/is not limited to those shown in FIG. 1. For example, the vehicle control apparatus 100 may include only some of the pieces of hardware shown in FIG. 1.

The vehicle control apparatus 100 according to an implementation may include hardware for processing data based on one or more instructions. For example, the hardware for processing the data may include the processor 110. For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa-core, or an octa core.

According to an implementation, the processor 110 may include at least one of a graphic processing unit (GPU) or a neural processing unit (NPU), or any combination thereof. For example, the GPU may be referred to as a visual processing unit (VPU). For example, the NPU may be referred to as a neural network processing unit.

The vehicle control apparatus 100 according to an implementation may include a sensor 120, such as a depth sensor, for detecting an external object. For example, the depth sensor for detecting the external object may include at least one of a time of flight (ToF) sensor, LiDAR, a structured light sensor, an ultrasonic sensor, an infrared sensor, radio detection and ranging (RADAR), or an optical distance sensor, or any combination thereof. Hereinafter, a description will be given of using LiDAR as the sensor 120 for convenience of description, but implementations are not limited thereto.

The vehicle control apparatus 100 according to an implementation may include the LiDAR sensor 120 for obtaining a plurality of points based on a pulse laser signal. For example, the LiDAR sensor 120 can obtain datasets for identifying a surrounding thing around the vehicle control apparatus 100 (or the vehicle including the vehicle control apparatus 100). For example, the LiDAR sensor 120 may identify at least one of a position of the surrounding thing, a motion direction of the surrounding thing, or a speed of the surrounding thing, or any combination thereof, based on that a pulse laser signal radiated from the LiDAR sensor 120 is reflected from the surrounding thing to return.

For example, the LiDAR sensor 120 may obtain datasets representing an external object in a space formed by an x-axis, a y-axis, and a z-axis, based on the pulse laser signal reflected from the surrounding thing. For example, the LiDAR sensor 120 can obtain datasets including a plurality of points in the space formed by the x-axis, the y-axis, and the z-axis, based on receiving the pulse laser signal at a specified period. For example, the plurality of points may include points representing the external object in a three-dimensional (3D) virtual coordinate system. The 3D virtual coordinate system may include at least one of a vehicle coordinate system or a LiDAR coordinate system, or any combination thereof. However, the example of the 3D virtual coordinate system is not limited to those described above.

The memory 130 of the vehicle control apparatus 100 according to an implementation may include a hardware component for storing data and/or an instruction input and/or output from the processor 110 of the vehicle control apparatus 100. For example, the memory 130 may include a volatile memory including a random-access memory (RAM) and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

One or more instructions indicating computation and/or an operation to be performed using data by the processor 110 of the vehicle control apparatus 100 may be stored in the memory 130 of the vehicle control apparatus 100. A set of the one or more instructions may be referred to as a program, firmware, an operating system, a process, a routine, a sub-routine, and/or an application.

Hereinafter, that the application is installed in the vehicle control apparatus 100 may mean that one or more instructions provided in the form of the application are stored in the memory 130, which may mean that the one or more applications are stored in a format executable by the processor 110 of the vehicle control apparatus 100 (e.g., as a file with an extension specified by the operating system of the vehicle control apparatus 100).

For example, the memory 130 may include a first neural network model for detecting an object. For example, the memory 130 may include a second neural network model for outputting a type of the plurality of points obtained by the LiDAR sensor 120 and/or a score of the plurality of points.

In an implementation, the processor 110 may obtain at least one of a first virtual box for representing a target object or a first class indicating a type of the target object, or any combination thereof, based on the plurality of points obtained via the LiDAR sensor 120 and the first neural network model stored in the memory 130.

In an implementation, the processor 110 may obtain at least one of the first virtual box for representing the target object or the first class indicating the type of the target object, or any combination thereof, based on inputting the plurality of points to the first neural network model. For example, the first neural network model may include an object detection model. For example, the target object may include an external object located within a specified distance from the vehicle control apparatus 100 (or a host vehicle including the vehicle control apparatus 100). For example, the target object may include an object which is identified by the vehicle control apparatus 100 and is tracked, e.g., continuously tracked. For example, the type of the target object may be one or more among a plurality of types for classifying the target object. For example, the type of the target object may include at least one of a first type indicating the ground or a second type indicating a type different from the ground, or any combination thereof. However, the type of the target object is not limited to those described above. For example, the type of the target object may include, but is not limited to, at least one of a third type indicating a person or a fourth type indicating a vehicle, or any combination thereof.

In an implementation, the processor 110 can obtain at least one of first partial points corresponding to at least a portion of the target object among the plurality of points, based on the plurality of points and the second neural network model or a second class identified via the first partial points and indicating the type of the target object, or any combination thereof, based on the plurality of points and the second neural network model. For example, the second neural network model can include a segmentation model.

For example, the second neural network model can include a neural network model for obtaining the type of the plurality of points and the score of the plurality of points.

For example, the processor 110 can obtain the first partial points corresponding to the at least a portion of the target object among the plurality of points, based on inputting the plurality of points to the second neural network model. For example, the processor 110 may identify the type of the plurality of points, based on inputting the plurality of points to the second neural network model. For example, the processor 110 may obtain the first partial points corresponding to the at least a portion of the target object among the plurality of points, based on the type of each of the plurality of points.

According to an implementation, the processor 110 may perform a first specified algorithm for the plurality of points. For example, the processor 110 may perform the first specified algorithm for classifying the type of each of the plurality of points, for the plurality of points. For example, the processor 110 may classify second partial points corresponding to a specified type among the plurality of points. For example, the specified type may include a type representing the ground.

For example, the processor 110 may classify the second partial points corresponding to the specified type, based on performing the first specified algorithm for the plurality of points, and may exclude the second partial points from the plurality of points to obtain (or identify) the first partial points.

In an implementation, the processor 110 may obtain at least one of a partial class for obtaining the second class, or the score of each of the plurality of points, or any combination thereof, based on inputting the plurality of points to the second neural network model. For example, the processor 110 may obtain the partial class and the score of each of the plurality of points, based on inputting the plurality of points to the second neural network model. For example, the partial class may include classifying each of the plurality of points as any type.

For example, the processor 110 may fuse the partial class, the score of each of the plurality of points, and the second partial points. For example, the processor 110 may perform clustering, based on fusing the partial class, the score of each of the plurality of points, and the second partial points. For example, the clustering may include grouping the first partial points corresponding to the at least a portion of the target object.

For example, the processor 110 may obtain a point cloud for generating a second virtual box, based on the first partial points. For example, the processor 110 may obtain the point cloud, based on grouping the first partial points.

For example, the processor 110 may generate the second virtual box which is different from the first virtual box and is for representing the target object, based on the point cloud. For example, the second virtual box may include a box including at least some of the first partial points.

For example, the processor 110 may identify a heading direction indicating a progress direction of the target object, based on at least one of the first partial points or the point cloud, or any combination thereof.

For example, the processor 110 may identify a position of the second virtual box on the virtual coordinate system, based on the at least one of the first partial points or the point cloud, or the any combination thereof. For example, the processor 110 may identify a size of the second virtual box, based on the at least one of the first partial points or the point cloud, or the any combination thereof. For example, the processor 110 may identify a second class, based on the at least one of the first partial points or the point cloud, or the any combination thereof.

For example, the processor 110 may identify at least one of the heading direction indicating the progress direction of the target object, the position of the second virtual box on the virtual coordinate system, the size of the second virtual box, or the second class, or any combination thereof, based on the at least one of the first partial points or the point cloud, or the any combination thereof. For example, the processor 110 may identify a heading direction of a bounding box, based on at least one of the first virtual box, the first class, the heading direction of the second virtual box, the position of the second virtual box, the size of the second virtual box, or the second class, or any combination thereof. For example, the processor 110 may identify a position of the bounding box on the virtual coordinate system, based on the at least one of the first virtual box, the first class, the heading direction of the second virtual box, the position of the second virtual box, the size of the second virtual box, or the second class, or the any combination thereof. For example, the processor 110 may obtain a third class indicating the type of the target object corresponding to the bounding box, based on the at least one of the first virtual box, the first class, the heading direction of the second virtual box, the position of the second virtual box, the size of the second virtual box, or the second class, or the any combination thereof. For example, the processor 110 may obtain at least one of the heading direction of the bounding box, the position of the bounding box on the virtual coordinate system, or the third class indicating the type of the target object corresponding to the bounding box, or any combination thereof, based on the at least one of the first virtual box, the first class, the heading direction of the second virtual box, the position of the second virtual box, the size of the second virtual box, or the second class, or the any combination thereof.

For example, the processor 110 may assign, to the second virtual box, a first identifier for tracking the second virtual box. For example, the processor 110 may assign, to the bounding box, a second identifier corresponding to the first identifier.

For example, the processor 110 may track the bounding box using the second identifier. For example, the processor 110 may track the target object, based on identifying a plurality of bounding boxes including the bounding box to which the second identifier is assigned, at a plurality of frames. For example, in scenarios where the second identifier is an identifier assigned to the bounding box corresponding to the target object, the processor 110 can identify the plurality of bounding boxes to which the second identifier is assigned, at the plurality of frames, to track the target object.

In an implementation, the processor 110 can output the bounding box corresponding to the target object, based on at least one of the first virtual box, the first class, the first partial points, or the second class, or any combination thereof. For example, the bounding box may include an example of representing the target object on the virtual coordinate system in the form of a hexahedron.

Hereinafter, a description will be given briefly of operations performed by the CPU, the GPU, and/or the NPU included in the processor 110.

According to an implementation, the processor 110 may include at least one of the CPU, the GPU, or the NPU, or any combination thereof. For example, at least one of the GPU or the NPU, or any combination thereof may obtain the first virtual box and the first class, based on the first neural network model. For example, at least one of the GPU or the NPU may obtain the first virtual box and the first class. For example, the at least one of the GPU or the NPU, or the any combination thereof may obtain the partial class for obtaining the second class and the score of each of the plurality of points, based on the second neural network model. For example, the at least one of the GPU or the NPU can obtain the partial class for obtaining the second class and the score of each of the plurality of points, based on the second neural network model. For example, the CPU may classify the second partial points corresponding to the specified type among the plurality of points, based on performing the first specified algorithm for classifying the type of each of the plurality of points, for the plurality of points.

As described above, the vehicle control apparatus 100 according to an implementation may include the at least one processor 110. The vehicle control apparatus 100 may detect the target object using the at least one processor 110 to accurately detect the target object. Furthermore, by performing a parallel process, the vehicle control apparatus 100 may reduce a load for each processor.

Object recognition is described next, including examples based on specific scenarios. Specifically, a description is provided of object recognition-related description based on LiDAR to facilitate understanding of AI object recognition according to the present disclosure.

In some implementations, an object recognition process by the LiDAR sensor 120 or the AI module passes through three steps, such as pre-processing, segmentation, and tracking.

Pre-processing can be performed by the object recognition system 1000, before executing an object recognition function. The pre-processing may include, for example, an operation of removing points forming the ground, based on laser sensing data (i.e., raw data) input from the LiDAR sensor 120. Because a laser beam reflected from the ground could be mistakenly recognized as an object on the ground, the process of distinguishing between the ground and non-ground objects is performed in a preprocessing operation, and in some scenarios, can also be performed in a segmentation operation.

For example, the pre-processing in AI object recognition can implement a process in which an image processing tool of the AI module in the processor 110 can, for example, remove noise of a LiDAR point cloud image, reduce the total number of points which are present in the LiDAR point cloud image via a voxel downsampling technique, or the like, to promote computational efficiency.

For reference, the LiDAR point cloud image may be displayed in a bird's eye view (BEV) scheme. If a LiDAR map is generated as if it were a bird's eye view of the city while the bird flies in the sky, this is referred to as a BEV image.

For example, as described above, the LiDAR sensor 120 transmits a laser beam to a surrounding environment and records a round-trip time during which the laser beam is reflected from an object which is present in the outside, thus generating a point for each of many laser signals, based on which a distance to the point can be calculated. By repeatedly transmitting many laser beams, the processor 110 can generate a real-time LiDAR map for the surrounding environment as a BEV type of 3D map and may generate the real-time LiDAR map as a two-dimensional (2D) map in some scenarios.

The line or surface shown in black and white on the LiDAR point cloud map can be composed of a large number of points (e.g., each of which is generated based on the laser beam of the LiDAR sensor 120). Due to this, a LiDAR sensing image is called a LIDAR point cloud image. In some implementations, if a red, green, blue-depth (RGB-D) sensor and the LiDAR sensor are combined with each other, the LiDAR point cloud image can be reconstructed in color.

Although can be difficult for humans to recognize objects using only one point in the LiDAR point cloud image, a comprehensive look at the point cloud from the BEV's point of view or in the same way as a 2D floor plan, a human viewer can obtain an approximate understanding of the surrounding environment around the vehicle which is performing autonomous driving. In addition, for example, it is possible to recognize a vehicle, a bus, a pedestrian, a street tree, a traffic sign, or the like which is present in the LiDAR point cloud image. Such a thing or person is called an object in an AI image recognition technology. It is possible to classify the object as a class which belongs to a group of the specific nature, such as a vehicle class or a bus class or the like.

In some implementations, machine-learning such as a deep AI neural network can be used to classify whether any object in the LiDAR point cloud image is the vehicle class or the bus class or the like. In some cases, AI training can be a precedent step that is performed, e.g., before deploying the AI neural network to find objects in the LiDAR point cloud image and identify a class of the object.

For example, a dataset (source: https://pandaset.org/#data-collection) called PANDASET™ includes more than 48,000 camera images (images captured primarily in the Silicon Valley region of the United States) and includes more than 16,000 LiDAR scan images. A total of 28 classes, such as pedestrians, cars, bicycles, construction site signs, and traffic signs, are arranged in the form of an annotation in these images.

Furthermore, the LiDAR point cloud image can be visualized to suit an option desired by the user using a point cloud working tool, such as Open3D™ (source: https://www.open3d.org/). Because the LiDAR sensor 120 is able to detect a distance, it may more realistically reproduce a 3D LiDAR image in such a manner as to display a thing in a long distance in, for example, a deep blue and display a thing in a short distance in a light blue, when the LiDAR point cloud image is visually processed using, for example, Open3D™.

In addition, as described above, in some implementations, technology such as voxel (3D pixel) downsampling can be applied to the LiDAR point cloud image to pre-process an original LiDAR image (i.e., raw data). Herein, the voxel refers to a 3D pixel in the shape of a regular hexahedron and the voxel downsampling is a technology for reducing the number of points not to require excessive AI computation, even while maintaining a structure of various objects included in the LiDAR point cloud.

In some implementations, the LiDAR sensor 120 radiates, for example, m laser beams n times during one scan cycle. In this case, the scan values of the laser beams that reflect from an external object collectively constitute an (m×n) matrix. This (m×n) matrix data is called a range image. Each point constituting the LiDAR point cloud image can include depth (e.g., range) information and can further include intensity, an azimuth, an inclination, or the other additional information of the reflected laser pulse. In some scenarios, the range image includes a large amount of datasets, for example, Waymo™ open dataset (WOD). As such, it is possible to perform AI learning of the range image.

A range view (RV) refers to a technique for converting a 3D point cloud into a 2D scene, for example, a 2.5D scene to represent the 3D point cloud as a 3D LiDAR map that humans are able to intuitively understand, like an analog picture, rather than a large number of points. The 3D LiDAR point cloud image has 2D coordinates in the range view image, but the 3D laser-related information (e.g., the angle, the inclination, the intensity, and the like) which is recorded when previously obtaining the range image is not discarded. If a variable called a width is applied to (x, y) coordinates among (x, y, z) coordinate values of the 3D LiDAR image to obtain a coordinate on one axis in two dimensions and range image information indicating a range (depth) and a variable called a height are applied to the (z) coordinate to obtain a coordinate of the other axis in two dimensions, this is generated as a 2D range view image.

In addition, the AI algorithm according to implementations of the present disclosure can include a convolutional neural network (CNN). The CNN can be trained by an AI training module to extract a feature (or a feature point) from image data. For example, the training can utilize a dataset composed of tens of thousands of commercially available images. The CNN can perform processing of each of one-dimensional to three-dimensional images. As such, the results of a range view image processing tool can be learned by the CNN to perform a function of helping AI to accurately recognize an object in an image.

In scenarios where objects around an autonomous vehicle is recognized through machine-learning, the operation of generating a ground truth (GT) bounding box on the above-mentioned LiDAR map is an important process in object recognition. Ground truth (GT) in machine learning is a term used when indicating an original value and a real value of data that AI is utilized to learn. It may be usually viewed as a kind of image annotation overlaid on the LiDAR point cloud image as a bounding box with a box-shaped boundary.

For example, to perform recognition of an object, the AI module can fetch a label to perform grouping of various objects. In some scenarios, an interval or spacing of 3D data points that are used to output a GT bounding box may be set, to allow, for example, approximately 50 to 1000 LiDAR point cloud points to be included in one GT bounding box.

In some scenarios, there is no GT annotation present in original data (or raw data) captured by the sensor, such as the LiDAR sensor 120, while the vehicle is driving. Thus, the processor 110 should perform recognition of a target which belongs to various classes, such as a road sign of the road, a crosswalk, a pedestrian, other vehicles, and a center line, as an object. The GT annotation is a technique used to compare the result of determining the object recognized by the AI algorithm of the processor 110 with reality to measure an error in object recognition and evaluate AI performance. A GT bounding box overlaid on the original image in the form of an annotation can be set manually by the user, or can be set through a GT computation tool, such as grid-striding.

AI object recognition can also utilize predicted bounding boxes. A predicted bounding box can represent a result of recognizing an object of a specific class by the processor 110 from the original image data obtained from sensors such as the LiDAR sensor 120. The predicted bounding box can appear similar to the GT bounding box. However, unlike the GT bounding box, the predicted bounding boxes are the result of being calculated by autonomous driving AI. The predicted bounding box may be identical to the GT bounding box, or may partially overlap the GT bounding box, or may not overlap at all with the GT bounding box.

For reference, because it can be difficult to definitively conclude that an object of a specific class is actually present at a specific position using only predicted bounding boxes, the predicted bounding boxes are usually called probability boxes (P-Boxes).

Segmentation processing cam be performed after the pre-processing. Segmentation processing can, for example, display a specific portion of a road (e.g., traffic lights) with a particular annotation (e.g., the color red) and display the other parts (e.g., bituminous road) using another annotation (e.g., the color blue). Clustering the point cloud into a certain group and generating a P-Box can be performed in the segmentation step. In some cases, cluster expansion can also be used, where an expansion target may include a cluster that is expanded to include all points within a given distance from the seed point plus an additional incremental distance epsilon (where the given distance constitutes the unexpanded cluster).

In some implementations, clustering based on the point cloud and P-Box generation can be performed during the segmentation processing. For example, an AI network which performs segmentation can be used to obtain a point label from data collected by sensors, such as the LiDAR 120.

Implementations of the present disclosure can utilize a “rule-based” road surface recognition and label fusion technique, which can help mitigate problems of ground surface recognition error which can occur upon segmentation. Such a road surface recognition algorithm can apply any of various techniques, such as road surface recognition based on a slope, grid-based road surface recognition, and the other non-planar based road surface recognition. Implementations of the present disclosure are described based on adopting a slope-based road surface recognition technique, if recognizing a road surface in a tunnel.

For reference, semantic segmentation can involve attaching a unique class label to respective points in the point cloud generated by the LiDAR sensor 120. The semantic segmentation in a LiDAR imaging technology can find and use meaningful information from LiDAR data for object recognition or scene representation to implement autonomous driving. Various semantic segmentation AI models can be used, such as a projection-based method, a point-based method, and a sparse convolution-based method. For example, the semantic segmentation result can be the AI computation result performed together with the NVIDIA DRIVE™ AGX system by the processor 110. Using such a configuration, various annotated such as colors can be added to, for example, the LiDAR point cloud image.

After performing the segmentation process described above, in some implementations, the LiDAR image can be undergo post-processing. Post-processing can involve converting point cloud data into a 3D map or modeling, which can be information meaningful for autonomous driving. Post-processing can also include, in some scenarios, removing noise of the LiDAR point cloud image or removing an error in the LiDAR point cloud image, recognizing an object, such as a vehicle or a pedestrian, from the point cloud, and attaching and registering a unique identifier to the point cloud information.

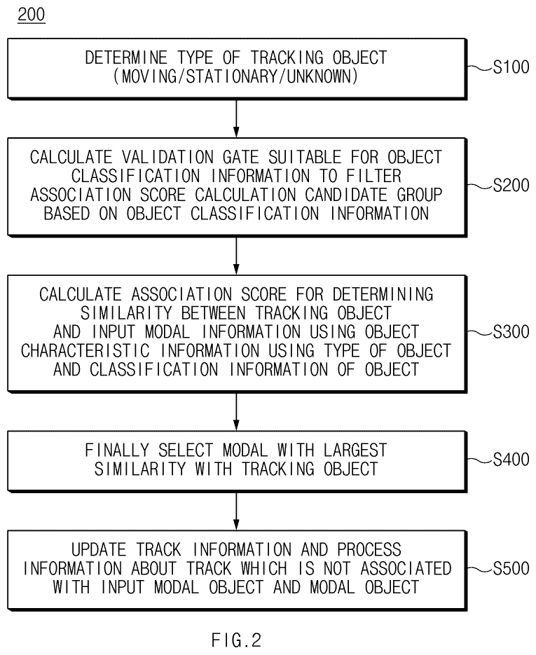

FIG. 2 is a flowchart illustrating an example of the overall process 200 of executing tracking association using characteristics of an object according to an implementation of the present disclosure.

According to implementations of the present disclosure, association can be performed based on a priority according to a type of a tracking object for multi-modal-based input information. This can have various technical benefits, such as improving association and maintenance performance for tracking an object, by leveraging deep learning-based input information to provide a box with a stable shape and stable classification information using an identified classification type.

During object recognition, an autonomous driving system can perform a process of recognizing objects of various classes, such as a vehicle, a vulnerable road user (VRU) (or a vulnerable road user such as a pedestrian), a road boundary, and a road structure. However, various problems can arise. For example, if the autonomous driving system applies the same association algorithm regardless of a recognized target, then this can result in deterioration in tracking performance. For example, problems may occur in which different types of recognized targets are merged with each other or are incorrectly associated with each other, resulting in incorrect recognition. Furthermore, in scenarios of limited computational, memory, and/or bandwidth resources, problems may occur if an important object cannot be recognized due to earlier-recognized objects occupying resources and hindering subsequent recognition efforts. Furthermore, in scenarios where association is performed based on information received from different interfaces (or with different signal structures and/or information formats) for different sensors, then problems may occur if one or more sensors or signals are modified or added, in which case the association logic software may also need to be modified accordingly.

Moreover, in some scenarios, the recognition targets of an autonomous driving system can have different sizes (or different shapes/speeds, etc.) and different output characteristics. However, if a gate with the same size (or the same valid range for determining an object as the same object) and the same association logic are applied, then this can result in recognition errors. For example, a problem can occur during object recognition whereby a pedestrian is merged with another adjacent recognized target (e.g., a vehicle, a road structure, etc.). This can result in driving control errors, for example, due to delayed and unexpectedly sudden recognition of the pedestrian while driving.

Implementations of the present disclosure can help address one or more of these problems. For example, according to implementations of the present disclosure association can be performed based on a priority that is assigned for each tracking channel. The priority can be assigned, as an example, in an order of a moving object, a stationary object, and an unknown object. This priority-based association can help reduce errors in which an object with a large recognition priority is not recognized, and can also help reduce a computation load (e.g., by dedicating resources to higher-priority tracking) and can improve an association error problem using identified classification type information, which is an advantage of deep learning-based modal input information.

Referring to the example flowchart of FIG. 2, in S100, a type of a tracking object can be determined. The type of the tracking object can be, for example, a moving object, a stationary object, an unknown object, or the like. As such, depending on the type of the object, tracking channels with high recognition importance can be assigned a higher priority. In addition to assigning a type to a tracking object, in some implementations, in S100, a scoring scheme can be used for determining a similarity. The scoring systems can use an algorithm that reflects the characteristics of each tracking object depending on the type of the tracking object.

In S200, a validation gate is calculated. For example, a validation gate that is suitable for the object classification information in S100 can be determined. The validation gate can be used to filter an association score calculation candidate group based on the object classification information determined in S100.

In S300, an association score can be determined. The association score can be used to determine a similarity between the tracking object and the input modal information. The similarity can be determined by using object characteristic information, which is based on the type of the object and the classification information of the object. In S400, a modal can be selected which has the largest similarity with the tracking object based on the calculated association score. Thereafter, in S500, the track information associated with the input modal object can be updated. For example, information such as a position, a speed, or a shape, can be updated for the track associated with the input modal object, by using modal information, In some scenarios, information about a track which is not associated with the input modal object can be disregarded or set aside.

Thus, by using a process as disclosed in the above example of S100 to S500, implementations of the present disclosure can perform association based on a priority that is assigned according to a type of the tracking object, and this association can further involve gate adjustment and score calculation using the object classification information. This can provide various technical benefits, such as reducing non-recognition errors and reducing errors in association by stably maintaining the tracking object.

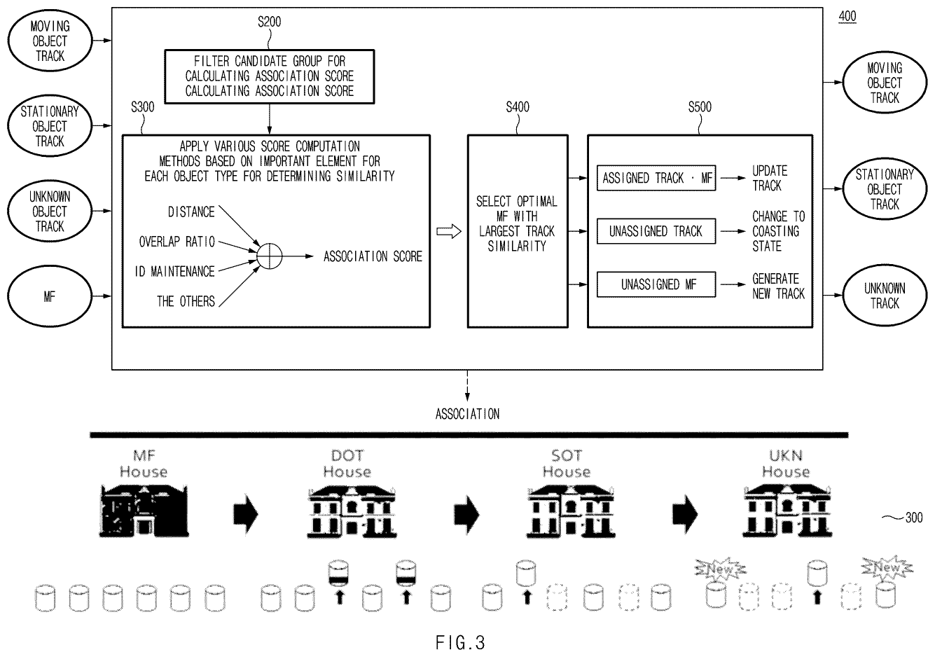

FIG. 3 is a block flowchart of an example of the overall process of executing tracking association using characteristics of an object. In particular, FIG. 3 illustrates an example process 400 from a functional perspective according to an implementation of the present disclosure.

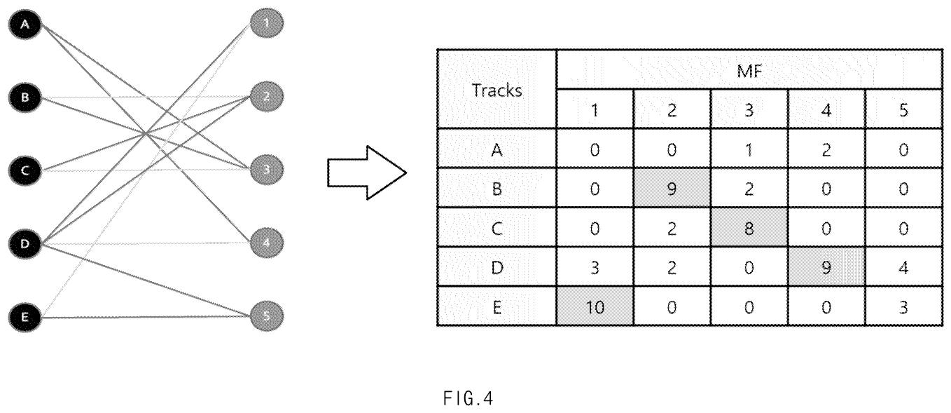

Referring to FIG. 3, the analyzed result performed in S100 of FIG. 2 may be input to an algorithm 200. For example, the input can be a moving object track, a stationary object track, an unknown object track, and meta-fusion (MF). Thus, in some implementations, the input part of FIG. 3 can correspond to S100 of FIG. 2. Furthermore, as described above, the algorithm 200 may be composed of S100 to S500, but in FIG. 4 only S200 to S500 are illustrated.

In S100 of FIG. 2 and the input part of FIG. 3, an algorithm is applied for assigning a priority to an object tracking channel with large recognition importance. The priority-assigning algorithm can reflect a characteristic for each channel depending to the type of the tracking object, which is determined in a tracking verification step in a previous step (T-1). As such, the algorithm can assign a priority that reflect an object's importance based on the characteristic for each type (e.g., moving/stationary/unknown) of the tracking object.

As an example, in S100 of FIG. 2 and the input part of FIG. 3, a first priority can be assigned to a moving object (e.g., a car, a bus, a truck, a pedestrian, or the like), a second priority can be assigned to a stationary object (e.g., a crosswalk, a road boundary, a speed bump, or the like), and a third priority can be assigned to an unknown object (e.g., a newly generated object, an object with an unclear type, or the like). However, implementations are not limited thereto.

In some implementations, association can be performed in an order of the assigned prioritization. In the example above, for input modal information, association can be performed in an order of a moving tracking channel, a stationary tracking channel, and an unknown tracking channel, which reflects the priorities assigned in an order of “moving”, “stationary”, and “unknown”. For example, association can first be performed for the highest-priority moving tracking channel, and then if the modal input still remains unassociated, then association can be performed for the next-highest priority stationary tracking channel.

In S200 of FIG. 3, candidates for calculating an association score can be filtered. For example, The association score can be used for determining a similarity between a tracking track and an input modal. The candidate for association score calculation can be determined for example, using deep learning-based modal input information that provides a box with a stable shape and classification information using the identified classification type. By filtering the modal corresponding to the candidates for calculating the association score, this can help reduce a system computation cost when calculating an association score for determining a similarity with the tracking object, and can reduce risk of mis-association between recognized targets with different characteristics.

In S200, a validation gate can be determined, suitable for the specific object classification information that was determined in S100. For example, if the classification type of the tracking track is a pedestrian, the classification information of the modal may select an object capable of being misclassified as a pedestrian (e.g., due to being similar to the pedestrian), such as a cyclist. In some scenarios, a cyclist can also be selected as a candidate, to account for the possibility of misclassification of a modal input based on deep learning. Thereafter, an object can be selected which has the potential be classified or misclassified as a general pedestrian, for example, an object that matches a position/speed within a range (e.g., including a margin) of a general pedestrian. Finally, for example, an object can be selected for which the distance between the pedestrian tracking track and the modal is within a particular distance, e.g., 2 meters. In some implementations, the validation gate can be adjusted considering pedestrian size information. For example, if the tracking object is a large bus, then the validation gate can be adjusted to a larger distance, e.g., 10 meters.

In S300 of FIG. 3, according to some implementations, various score computation techniques can be applied, for example based on an important element for each object type for determining a similarity. For example, when calculating the association score for determining similarity between the tracking object and the input modal information, elements such as a normalized weight, an overlap cost, and a distance cost can be calculated, as shown in Equation 1 below. In some implementations, a detailed association algorithm can be utilized, which is configured to be suitable for each characteristic depending on a tracking object type. For example, a reference point for distance calculation can be adaptively changed.

$$cost = {W}_{dist} * {C}_{dist} + {W}_{overlap} * {C}_{overlap} \qquad < Equation 1 >$$

Herein, W_{dist}+Wₒᵥₑᵣₗₐₚ=1. Furthermore, if the condition A_{Track}>A_{MF} is satisfied, then an equation such as Equation 2-1 below, can be used. Otherwise, if the condition above is not satisfied, then an equation such as Equation 2-2 below, can be used.

$${W}_{dist} = 1 - 0.5 * \frac{{A}_{MF}}{{A}_{track}} \qquad < Equation 2 - 1 >$$

$${W}_{overlap} = 1 - {W}_{dist}$$

$${C}_{dist} = {r}^{T} {S}^{inv} r$$

$${C}_{overlap} = 1 - \frac{{A}_{overlap}}{{A}_{MF}}$$

$${W}_{dist} = 1 - 0.5 * \frac{Atrack}{{A}_{MF}} \qquad < Equation 2 - 2 >$$

$${W}_{overlap} = 1 - {W}_{dist}$$

$${C}_{dist} = {r}^{T} {S}^{inv} r$$

$${C}_{overlap} = 1 - \frac{{A}_{overlap}}{{A}_{track}}$$

As a result, score computation in S300 can be performed using an equation such as Equation 3 shown below.

$$score = \frac{1}{cost} * scale factor \qquad < Equation 3 >$$

The variables shown in Equations 1 to 3 above are described in Table 1 below.

TABLE 1
W_{dist}: normalized distance weight
Wₒᵥₑᵣₗₐₚ: normalized overlap weight
C_{dist}: distance cost
Cₒᵥₑᵣₗₐₚ: normalized overlap ratio cost
A_{track/meta}: track/MF area
Aₒᵥₑᵣₗₐₚ: overlappedarea
Dₘₐₓ: diagonal distance of track box
D_{close}: closet distance between track CP and MF box point
r: residual between track and MF
S: covariance of the difference between state values of track and MF

Referring to FIG. 3, in S400 of FIG. 3, an MF can be selected which has the largest track similarity. For example, based on the association score determined in S300, optimal association (i.e., matching) can be performed between the tracking object and the modal input. For example, S400 can involve selecting the modal input that has largest similarity with the tracking object, through global optimization.

In some implementations, if the association score has already been determined by reflecting the object type characteristic, it is possible to operate using the same algorithm in the optimal association (i.e., matching) step, without separately accounting for a tracking channel type (e.g., regardless of “moving”, “stationary”, “unknown”).

In S400, a so-called Hungarian algorithm can be used to help ensure that the final modal selection to be associated with the track is optimal matching in which the sum of the similarities between the track and the modal becomes maximum. FIG. 4 illustrates an example of an adoptable Hungarian algorithm according to an implementation of the present disclosure.

In S500 of FIG. 3, if there is association between a track and an input modal, then track information (e.g., a position, a shape, or a speed of the track) can be updated using the associated modal information to perform tracking.

By contrast, if there is no association between the track and the input modal, then a tracking state can be changed to a coasting state, rather than updating the tracking state, so as to maintain the track during a certain duration. In such scenarios, the track is not immediately deleted. Such features can provide various technical benefits. For example, maintaining the track without immediately deleting the track can enable responding to a case of non-detection of the modal input, for example in scenarios of momentary non-detection of the modal input or communication delays in the modal input.

Furthermore, according to some implementations, if the input modal object is not associated with a track, then a new track can be generated using the input modal information. The generation of the new track can be performed, for example, in only an “unknown” tracking channel. Because a newly generated track may not have sufficient validation verification, in some scenarios the newly generated track may be adjusted to a “moving” or “stationary” object after verification is completed in the “unknown” tracking channel. This technique can help avoid problems in which recognition stability is degraded due to mis-association and frequent change in object type, which can occur if an “unknown” track is immediately generated as a “moving” or “stationary” object without the above-described stability measures.

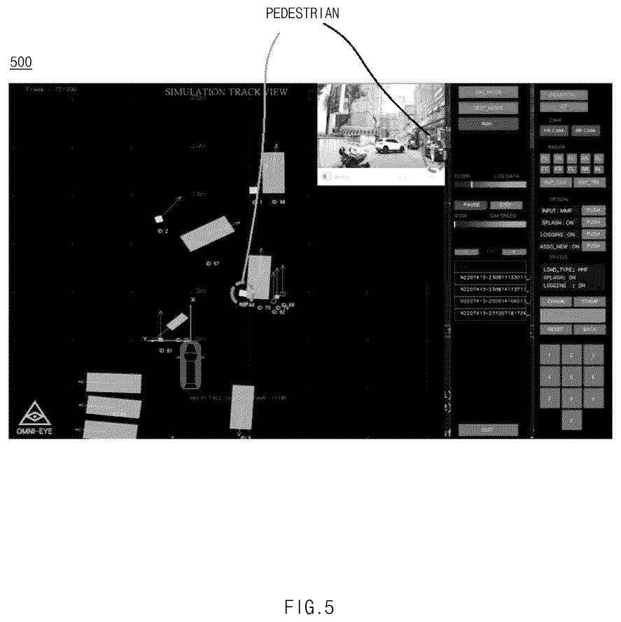

FIG. 5 is an example experimental result 500 illustrating that objects with different adjacent pieces of classification information and characteristics are recognized with improved separation performance as a result of executing tracking association using characteristics of an object according to an implementation of the present disclosure.

Referring to FIG. 5, implementations of the present disclosure can perform association based on a priority (e.g., in an order of a “moving” object, a “stationary” object, and an “unknown” object) to improve an error in which an object (i.e., a pedestrian) with a large recognition priority is not recognized while driving. Implementations of the present disclosure can improve an association error using identified classification type information which is an advantage of deep learning-based modal input information and may improve track maintenance performance. For example, if algorithms 200 and 400 according to the present disclosure are applied, objects with different adjacent pieces of classification information and characteristics can be recognized with improved separation performance and recognition may be stably maintained.

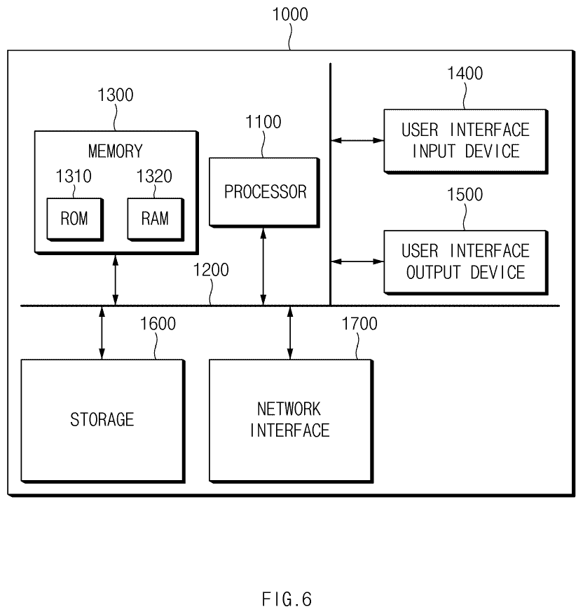

FIG. 6 is a block diagram illustrating a computing system 1000 for autonomous vehicle control and object recognition computation according to an implementation of the present disclosure.

Referring to FIG. 6, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the implementations disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

What is claimed is:

1. An artificial intelligence (AI)-based system configured to recognize and track an object in conjunction with an autonomous driving sensor, the system comprising:
at least one processor;
at least one memory storing computer program instructions that, based on being executed by the at least one processor, perform operations of object recognition for a surrounding environment, the operations comprising:
obtaining a plurality of pieces of point data from an autonomous driving sensor;
generating a tracking channel for a tracking object by processing the plurality of pieces of point data;
determining classification information and a classification type for the tracking object based on processing the plurality of pieces of point data;
assigning a priority value to the tracking channel depending on the classification information and the classification type for the tracking object;
determining a validation gate depending on the classification information and the classification type of the tracking object;
filtering a plurality of candidate modals for an association score calculation to generate an association score calculation candidate group;
determining a plurality of association scores based on the classification type of the tracking object, the classification information of the tracking object, and the association score calculation candidate group;
selecting a modal that has a largest similarity with the tracking object based on the calculated plurality of association scores; and
processing information about the selected modal and updating track information for the selected modal.

2. The system of claim 1, wherein the classification type of the tracking object is at least one of a moving object type, a stationary object type, or an unknown object type.

3. The system of claim 2, wherein the priority value for the tracking channel of the autonomous driving sensor is determined to have a priority order of the moving object type, the stationary object type, and the unknown object type.

4. The system of claim 3, wherein the operations further comprise performing association for modal information obtained from the autonomous driving sensor, wherein the association is performed in the priority order of the moving object type, the stationary object type, and the unknown object type.

5. The system of claim 1, wherein the determining of the validation gate and the filtering of the plurality of candidate modals are performed based on the classification information of the tracking object and based on deep learning-based modal input information.

6. The system of claim 1, wherein the validation gate is variably determined based on the classification type of the tracking object and the classification information of the tracking object.

7. The system of claim 2, wherein the updating of the track information for the selected modal includes generating a new track, and
wherein the new track corresponding to the moving object type or the stationary object type is generated after verification in a channel for the unknown object type is completed.

8. The system of claim 1, further comprising multiple sensors including the autonomous driving sensor,
wherein an input from the multiple sensors comprises data that has compatibility with an interface in a standardized format.

9. The system of claim 1, further comprising:
based on a determination of an association between a track and an input modal, performing an update of track information including a position, a shape, and a speed of the track, using associated modal information, if there is association between the track and an input modal, and
based on a determination of no association between the track and the input modal, the track is maintained for a period of time in a coasting state.

10. The system of claim 1, wherein the selecting of the modal that has largest similarity with the tracking object comprises:
executing a Hungarian algorithm to determine a matching in which a sum of similarities between a track and a modal is maximum.

11. An artificial intelligence (AI)-based method for recognizing and tracking an object in conjunction with an autonomous driving sensor, the method comprising:
obtaining a plurality of pieces of point data from an autonomous driving sensor;
generating a tracking channel for a tracking object by processing the plurality of pieces of point data;
determining classification information and a classification type for the tracking object based on processing the plurality of pieces of point data;
assigning a priority value to the tracking channel depending on the classification information and the classification type for the tracking object;
determining a validation gate depending on the classification information and the classification type of the tracking object;
filtering a plurality of candidate modals for an association score calculation to generate an association score calculation candidate group;
calculating a plurality of association scores based on the classification type of the tracking object, the classification information of the tracking object, and the association score calculation candidate group;
selecting a modal that has a largest similarity with the tracking object based on the calculated plurality of association scores; and
processing information about the selected modal and updating track information for the selected modal.

12. The method of claim 11, wherein the classification type of the tracking object is at least one of a moving object type, a stationary object type, or an unknown object type.

13. The method of claim 12, wherein the priority value for the tracking channel of the autonomous driving sensor is determined to have a priority order of the moving object type, the stationary object type, and the unknown object type.

14. The method of claim 13, wherein the operations further comprise performing association for modal information obtained from the autonomous driving sensor, wherein the association is performed in the priority order of the moving object type, the stationary object type, and the unknown object type.

15. The method of claim 11, wherein the determining of the validation gate and the filtering of the plurality of candidate modals are performed based on the classification information of the tracking object and based on deep learning-based modal input information.

16. The method of claim 11, wherein the validation gate is variably determined based on the classification type of the tracking object and the classification information of the tracking object.

17. The method of claim 12, wherein the updating of the track information for the selected modal includes generating a new track, and
wherein the new track corresponding to the moving object type or the stationary object type is generated after verification in a channel for the unknown object type is completed.

18. The method of claim 11, further comprising multiple sensors including the autonomous driving sensor,
wherein an input from the multiple sensors comprises data that has compatibility with an interface in a standardized format.

19. The method of claim 11, further comprising:
based on a determination of an association between a track and an input modal, performing an update of track information including a position, a shape, and a speed of the track, using associated modal information, if there is association between the track and an input modal, and
based on a determination of no association between the track and the input modal, the track is maintained for a period of time in a coasting state.

20. The method of claim 11, wherein the selecting of the modal that has largest similarity with the tracking object comprises:
executing a Hungarian algorithm to determine a matching in which a sum of similarities between a track and a modal is maximum.
